(19) United States
(12) Patent Application Publication
(10) Pub. No.: US 2006/0222103 A1
(43) Pub. Date: Oct. 5, 2006

(54) Radio transmission apparatus with variable frequency bandwidth of transmission signal or variable method of modulating transmission signal

(75) Inventors: Chikako Kobayashi, Gifu (JP); Masahiro Narita, Gifu (JP)

Correspondence Address: FOLEY AND LARDNER LLP;SUITE 500, 3000 K STREET NW, WASHINGTON, DC, 20007, US

(73) Assignee: Sanyo Electric Co., Ltd.

(21) Appl. No.: 11/389,019

(22) Filed: Mar. 27, 2006

(30) Foreign Application Priority Data
Mar. 30, 2005 (JP) 2005-097843

(51) Int. Cl. H04L 25/49

(52) U.S. Cl. 375/297

(57) ABSTRACT

A signal processing circuit receives an output of a modulation circuit to perform amplification, filtering and mixing on the output so as to generate a signal having a selected frequency bandwidth. A modulation signal output control circuit refers to a table to specify the level of the signal output from the modulation circuit that corresponds to the selected frequency bandwidth of the transmission signal, and instructs the modulation circuit to set, to the specified level, the modulated signal that is to be output. An AGC amplifier amplifies the output of the signal processing circuit to a reference level. Here, the table defines the correspondence in such a manner that, as the frequency bandwidth of the transmission signal is larger, the level of the signal to be output from the modulation circuit decreases.

### BACKGROUND OF THE INVENTION

1. Field of the Invention

The present invention relates to a radio transmission apparatus. In particular, the invention relates to a radio transmission apparatus using variable frequency bandwidth of transmission signals or variable method of modulating transmission signals.

2. Description of the Background Art

Some techniques have been proposed for reducing the cost of a radio transmission apparatus, for example, of a PHS (Personal Handyphone System) base station and a terminal.

For example, Japanese Patent Laying-Open No. 10-209935 discloses a radio transmission apparatus allowing signals of multiple lines to be transmitted/received without using a synthesizer. These lines use a cross switch 160 and transmission/reception switches 109, 110 in order that any of transmission/reception antennas 101 to 104 may be used for transmission. According to switching of the switches, PLL control units 137, 138 are adjusted that control PLL in transmitting and receiving operations. The radio-related circuitry can thus be simplified.

Further, a radio transmission apparatus is proposed that uses variable frequency bandwidth of transmission signals for the PHS for example.

FIG. 10 shows frequency components of a narrowband transmission signal and a wideband transmission signal.

Referring to FIG. 10, regarding the narrowband transmission signal with the frequency bandwidth 192 KHz, points of adjacent channels are ±600 KHz and ±900 KHz. In this case, distortions of the carrier wave do not extend to the adjacent channel points.

In contrast, regarding the wideband transmission signal with the frequency bandwidth 600 KHz, adjacent channel points are ±900 KHz and ±1200 KHz. In this case, the fifth-order distortion of the carrier wave extends to or beyond the adjacent channel points. Therefore, in order to make the waveform distortions smaller, it is required that components of the radio transmission apparatus have linearity.

Thus, the radio transmission apparatus using the variable frequency bandwidth of transmission signals has to have specs that allow the waveform distortion to be smaller even when transmission signals of the broadest bandwidth are transmitted. Components of the apparatus are required to have superior linearity sufficient to satisfy such specs, resulting in an increase in cost.

A radio transmission apparatus using variable method of modulating transmission signals also encounters similar problems.

### SUMMARY OF THE INVENTION

An object of the present invention is therefore to provide a radio transmission apparatus with variable frequency bandwidth of transmission signals or variable method of modulating transmission signals that can be manufactured at low cost.

A radio transmission apparatus according to one aspect of the present invention is a radio transmission apparatus with variable frequency bandwidth of a transmission signal, including: a modulation circuit modulating the transmission signal to generate a modulated signal; a signal processing circuit receiving an output of the modulation circuit to perform amplification, filtering and mixing on the output and thereby generate a signal having a selected frequency bandwidth; a table defining correspondence between each frequency bandwidth of the transmission signal and the level of a signal output from the modulation circuit; a control circuit referring to the table to specify the level of the signal output from the modulation circuit that corresponds to the selected frequency bandwidth of the transmission signal, and instructing the modulation circuit to set, to the specified level, the level of the modulated signal that is to be output; and an AGC amplifier amplifying an output of the signal processing circuit to a reference level. In the table, the correspondence is defined in such a manner that, as the frequency bandwidth of the transmission signal is larger, the level of the signal output from the modulation circuit decreases.

A radio transmission apparatus according to another aspect of the present invention is a radio transmission apparatus with variable method of modulating a transmission signal, including: a modulation circuit modulating the transmission signal by a modulation method selected from a plurality of modulation methods to generate a modulated signal; a signal processing circuit receiving an output of the modulation circuit to perform amplification, filtering and mixing on the output; a table defining correspondence between each modulation method for the transmission signal and the level of a signal output from the modulation circuit; a control circuit referring to the table to specify the level of the signal output from the modulation circuit that corresponds to the modulation method selected, and instructing the modulation circuit to set, to the specified level, the level of the modulated signal that is to be output; and an AGC amplifier amplifying an output of the signal processing circuit to a reference level.

In accordance with the present invention, a radio transmission apparatus with variable frequency bandwidth or variable modulation method of transmission signals can be manufactured at low cost.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of a radio transmission apparatus according to a first embodiment.

FIG. 2 shows an exemplary table in the first embodiment.

FIG. 3 shows changes in level of signals in the first embodiment.

FIG. 4 shows a structure of a radio transmission apparatus according to a second embodiment.

FIG. 5A is a signal space diagram of the π/4-shift QPSK modulation method, and FIG. 5B is a signal space diagram of the 16 QAM modulation method.

FIG. 6 shows an exemplary table in the second embodiment.

FIG. 7 shows changes in level of signals in the second embodiment.

FIG. 8 shows a structure of a radio transmission apparatus of a modification.

FIG. 9 shows an exemplary table of the modification.

FIG. 10 shows frequency components of a narrowband transmission signal and a wideband transmission signal.

### DESCRIPTION OF THE PREFERRED EMBODIMENTS

Embodiments of the present invention are hereinafter described in conjunction with the drawings.

### First Embodiment

Structure

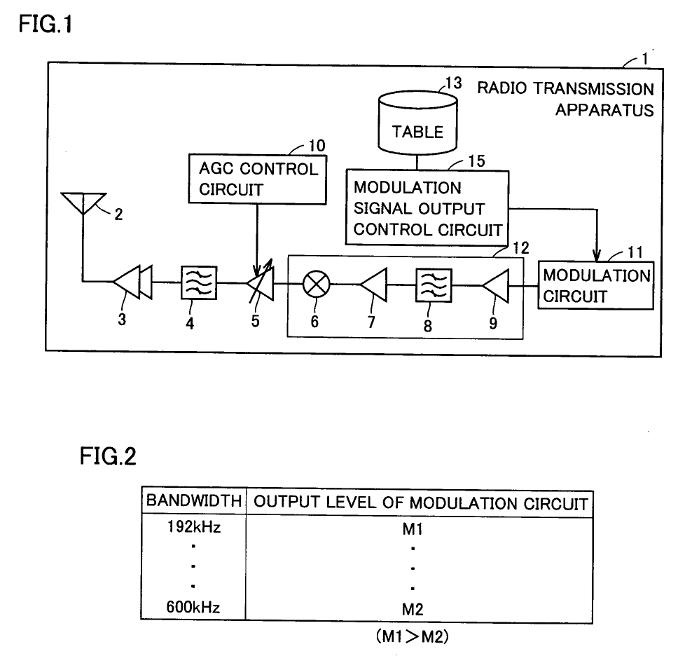

FIG. 1 shows a structure of a radio transmission apparatus according to a first embodiment.

Referring to FIG. 1, this radio transmission apparatus 1 includes a modulation circuit 11, a signal processing circuit 12, an AGC (Auto Gain Control) amplifier 5, a bandpass filter 4, a high-power amplifier 3, an antenna 2, an AGC control circuit 10, a table 13, and a modulation signal output control circuit 15. Signal processing circuit 12 includes an amplifier 9, a bandpass filter 8, an amplifier 7, and a mixer 6.

Modulation circuit 11 modulates a transmission signal according to a predetermined modulation method (for example π/4-shift QPSK (Quadrature Phase Shift Keying)).

Amplifier 9 amplifies the signal that is output from modulation circuit 11.

Bandpass filter 8 removes unnecessary frequency components of the signal that is output from amplifier 9.

Amplifier 7 amplifies the signal that is output from bandpass filter 8.

Mixer 6 converts the signal that is output from amplifier 7 into a signal having a frequency bandwidth selected from a plurality of frequency bandwidths (frequency bandwidths of 192 KHz, 600 KHz for example).

AGC control circuit 10 provides a reference level to AGC amplifier 5.

AGC amplifier 5 amplifies the signal that is output from mixer 6 to the reference level.

Bandpass filter 4 removes unnecessary frequency components from the signal that is output from AGC amplifier 5.

High-power amplifier 3 amplifies the signal that is output from bandpass filter 4 to a higher level to be transmitted by antenna 2.

Antenna 2 transmits the signal that is output from high-power amplifier 3.

Table 13 defines correspondence between each frequency bandwidth of the transmission signal and the level of the signal that is output from modulation circuit 11.

FIG. 2 shows an example of table 13 in the first embodiment.

Referring to FIG. 2, as the frequency bandwidth of the transmission signal is larger, the level of the signal that is output from modulation circuit 11 decreases. For example, in the case where the frequency bandwidth of the transmission signal is 192 KHz, the level of the signal output from modulation circuit 11 is M1. In the case where the transmission signal has the frequency bandwidth 600 KHz, the level of the signal output from modulation circuit 11 is M2. Here, there is the relation M1>M2.

Modulation signal output control circuit 15 refers to table 13 to specify the level of the signal to be output from modulation circuit 11 that corresponds to a selected frequency bandwidth of the transmission signal, and instructs modulation circuit 11 to set, to the specified level, the level of the modulated signal to be output.

Modulation circuit 11 uses its internal amplifier to amplify the modulated signal to the level specified by modulation signal output control circuit 15.

Example of Operation

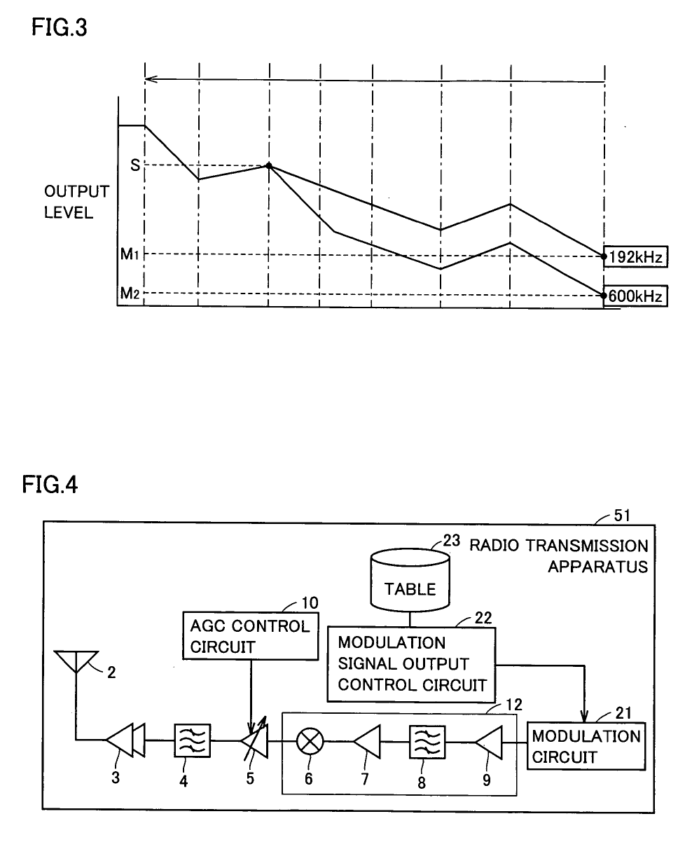

FIG. 3 shows changes in level of signals in the first embodiment.

Referring to FIG. 3, regarding the transmission signal with a frequency bandwidth of 192 KHz, the level of the signal when output from modulation circuit 11 is M1. Regarding the transmission signal with a frequency bandwidth of 600 KHz, the level of the signal when output from modulation circuit 11 is M2. Here, there is the relation M1>M2.

After this, both of the transmission signal with the frequency bandwidth 192 KHz and the transmission signal with the frequency bandwidth 600 KHz are increased in level by amplifier 9, decreased in level by bandpass filter 8, increased in level by amplifier 7, and increased in level by mixer 6.

After this, both of the transmission signal with the frequency bandwidth 192 KHz and the transmission signal with the frequency bandwidth 600 KHz are increased in level by AGC amplifier 5 to a reference level S.

After this, both of the transmission signal with the frequency bandwidth 192 KHz and the transmission signal with the frequency bandwidth 600 KHz are decreased in level by bandpass filter 4 and increased in level by high-power amplifier 3.

As discussed above, the radio transmission apparatus in the first embodiment lowers the level of the signal to be output from modulation circuit 11 as the frequency bandwidth increases. Accordingly, the level of the signal that is input to amplifier 9, bandpass filter 8, amplifier 7, and mixer 6 that are components in signal processing circuit 12 decreases. Thus, it is unnecessary to require these components to be of high spec and high cost while the linearity of the components can be ensured.

### Second Embodiment

Structure

FIG. 4 shows a structure of a radio transmission apparatus according to a second embodiment.

Referring to FIG. 4, this radio transmission apparatus 51 differs in structure from radio transmission apparatus 1 in the first embodiment shown in FIG. 1 in that the former apparatus includes a modulation circuit 21 instead of modulation circuit 11, a table 23 instead of table 13, and a modulation signal output control circuit 22 instead of modulation signal output control circuit 15. In the following, these components are described.

Modulation circuit 21 modulates a transmission signal according to a modulation method selected from a plurality of modulation methods (π/4-shift QPSK, 16 QAM (Quadrature Amplitude Modulation) and other multilevel modulation methods).

Table 23 defines correspondence between the modulation method of the transmission signal and the level of the signal to be output from modulation circuit 21.

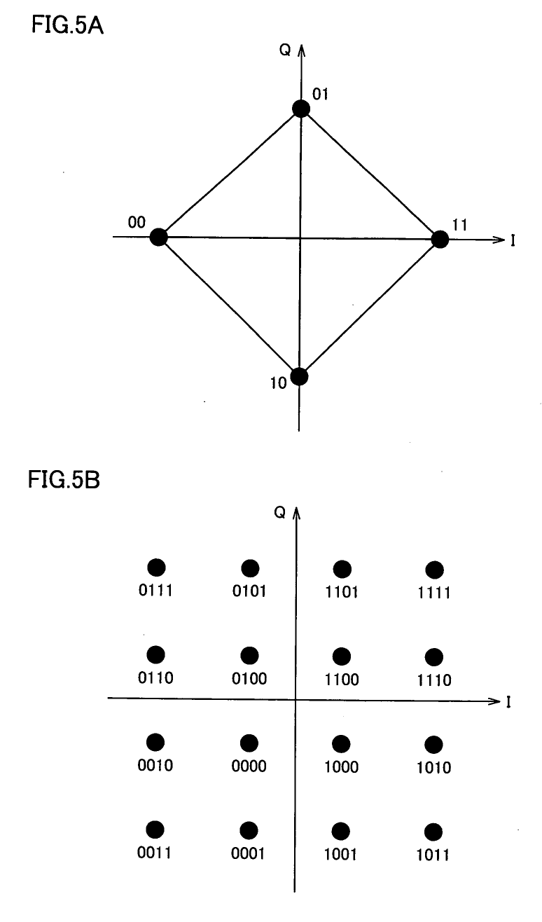

FIG. 5A is a signal space diagram of the π/4-shift QPSK modulation method.

FIG. 5B is a signal space diagram of the 16 QAM modulation method.

As for the 16 QAM, as compared with the π/4-shift QPSK, the difference between the level (or electric power) of each signal point and the average signal level is large. Each component in signal processing circuit 12 is designed to meet the linearity requirement at and around the average signal level. Therefore, in order to ensure the linearity for the transmission signal of the 16 QAM modulation method, the level of the signal that is input to each component in signal processing circuit 12 has to be decreased.

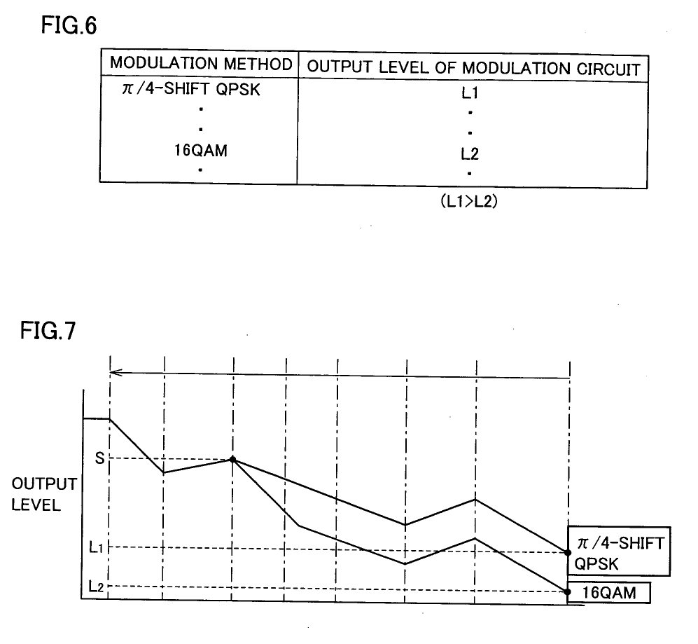

FIG. 6 shows an example of the table in the second embodiment.

Referring to FIG. 6, depending on the method of modulating the transmission signal, the level of the signal to be output from modulation circuit 21 is changed. For example, in the case where the modulation method is the π/4-shift QPSK, the level of the signal that is output from modulation circuit 21 is L1. In the case where the modulation method is the 16 QAM, the level of the signal output from modulation circuit 21 is L2. Here, there is the relation L1>L2.

Modulation signal output control circuit 22 refers to table 23 to specify the level of the signal output from modulation circuit 21 that corresponds to a selected modulation method, and instructs modulation circuit 21 to set, to the specified level, the level of the modulated signal to be output.

Modulation circuit 21 uses its internal amplifier to amplify the modulated signal to the level specified by modulation signal output control circuit 22.

Example of Operation

FIG. 7 shows changes in level of signals in the second embodiment.

Referring to FIG. 7, regarding the transmission signal of the modulation method π/4-shift QPSK, the level of the signal when output from modulation circuit 21 is L1. Regarding the transmission signal of the modulation method 16 QAM, the level of the signal when output from modulation circuit 21 is L2. Here, there is the relation L1>L2.

After this, both of the transmission signal according to the modulation method π/4-shift QPSK and the transmission signal according to the modulation method 16 QAM are increased in level by amplifier 9, decreased in level by bandpass filter 8, increased in level by amplifier 7, and increased in level by mixer 6.

After this, both of the transmission signal according to the modulation method π/4-shift QPSK and the transmission signal according to the modulation method 16 QAM are increased in level by AGC amplifier 5 to reference level S.

After this, both of the transmission signal according to the modulation method π/4-shift QPSK and the transmission signal according to the modulation method 16 QAM are decreased in level by bandpass filter 4 and increased in level by high-power amplifier 3.

As discussed above, regarding the radio transmission apparatus in the second embodiment, the level of the signal that is output from modulation circuit 21 is lower in the case where the transmission signal is modulated by the 16 QAM modulation method as compared with the case where the transmission signal is modulated by the π/4-shift QPSK. Accordingly, the level of the signal that is input to amplifier 9, bandpass filter 8, amplifier 7, and mixer 6 that are components in signal processing circuit 12 is lower. Thus, it is unnecessary to require these components to be of high spec and high cost while the linearity of the components can be ensured.

Modifications

The present invention is not limited to the above-described embodiments and includes for example the following modifications.

(1) Structure Using Variable Amplifier

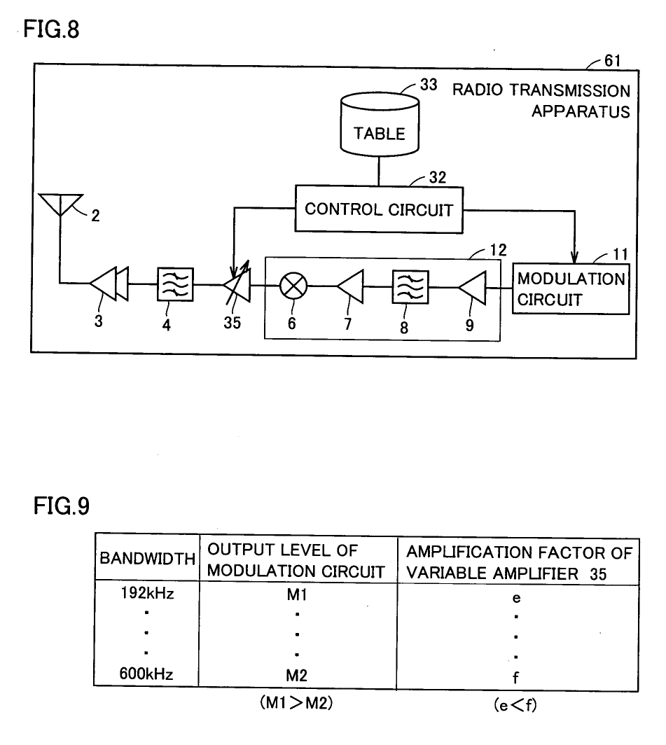

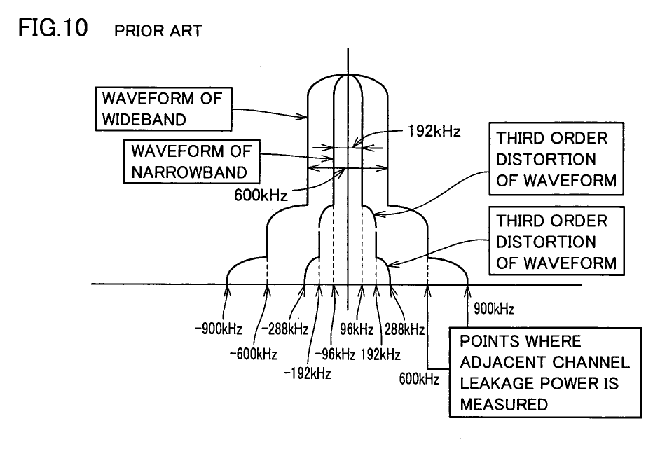

FIG. 8 shows a structure of a radio transmission apparatus of a modification.

Referring to FIG. 8, this radio transmission apparatus 61 differs in structure from radio transmission apparatus 1 in the first embodiment shown in FIG. 1 in that the former apparatus includes a variable amplifier 35 instead of AGC amplifier 5, a table 33 instead of table 13, and a control circuit 32 instead of AGC control circuit 10 and modulation signal output control circuit 15. Respective structures of these components are hereinafter described.

FIG. 9 shows an example of table 33 of the modification.

Referring to FIG. 9, as the frequency bandwidth of the transmission signal is larger, the level of the signal that is output from modulation circuit 11 decreases and the amplification factor of variable amplifier 35 increases.

For example, in the case where the transmission signal has the frequency bandwidth 192 KHz, the level of the signal to be output from modulation circuit 11 is M1 and the amplification factor of variable amplifier 35 is “e”. In the case where the transmission signal has the frequency bandwidth 600 KHz, the level of the signal to be output from modulation circuit 11 is M2 and the amplification factor of variable amplifier 35 is “f”. Here, there are relations M1>M2 and e<f.

The level of the signal output from modulation circuit 11 as well as the amplification factor of variable amplifier 35 are adjusted so that the output level of variable amplifier 35 is reference level S.

Variable amplifier 35 amplifies the signal that is output from mixer 6 at an amplification factor specified by control circuit 32.

Control circuit 32 refers to table 33 to specify the level of the signal output from modulation circuit 11 that corresponds to a selected frequency bandwidth of the transmission signal, and instructs modulation circuit 11 to set, to the specified level, the level of the modulated signal to be output.

Further, control circuit 32 refers to table 33 to specify the amplification factor of variable amplifier 35 that corresponds to the selected frequency bandwidth of the transmission signal, and instructs variable amplifier 35 to amplify the signal at the specified amplification factor.

(2) Modulation Circuit

According to the embodiments of the present invention, modulation circuits 11, 21 each use their internal amplifier to amplify the modulated signal to the level specified by modulation signal output control circuits 15, 22. The present invention, however, is not limited to this operation. Modulation circuits 11, 21 may change the magnitude of the digital signal before being modulated to allow the level of the signal output from modulation circuits 11, 21 to be any level specified by modulation signal output control circuits 15, 22.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A radio transmission apparatus with variable frequency bandwidth of a transmission signal, comprising:
a modulation circuit modulating the transmission signal to generate a modulated signal;
a signal processing circuit receiving an output of said modulation circuit to perform amplification, filtering and mixing on said output and thereby generate a signal having a selected frequency bandwidth;
a table defining correspondence between each frequency bandwidth of the transmission signal and the level of a signal output from said modulation circuit;
a control circuit referring to said table to specify the level of the signal output from said modulation circuit that corresponds to the selected frequency bandwidth of the transmission signal, and instructing said modulation circuit to set, to said specified level, the level of the modulated signal that is to be output; and
an AGC amplifier amplifying an output of said signal processing circuit to a reference level, wherein
in said table, the correspondence is defined in such a manner that, as the frequency bandwidth of the transmission signal is larger, the level of the signal output from said modulation circuit decreases.

2. A radio transmission apparatus with variable method of modulating a transmission signal, comprising:
a modulation circuit modulating the transmission signal by a modulation method selected from a plurality of modulation methods to generate a modulated signal;
a signal processing circuit receiving an output of said modulation circuit to perform amplification, filtering and mixing on said output;
a table defining correspondence between each modulation method for the transmission signal and the level of a signal output from said modulation circuit;
a control circuit referring to said table to specify the level of the signal output from said modulation circuit that corresponds to said modulation method selected, and instructing said modulation circuit to set, to said specified level, the level of the modulated signal that is to be output; and
an AGC amplifier amplifying an output of said signal processing circuit to a reference level.
